(19) United States
(12) Patent Application Publication
(10) Pub. No.: US 2017/0147598 A1
(43) Pub. Date: May 25, 2017

(54) FILE SYSTEM, DATA DEDUPLICATION METHOD AND STORAGE MEDIUM

(71) Applicants: KABUSHIKI KAISHA TOSHIBA, Tokyo (JP); TOSHIBA SOLUTIONS CORPORATION, Kawasaki-shi (JP)

(72) Inventor: Shoichi SAWADA, Tokyo (JP)

(73) Assignees: KABUSHIKI KAISHA TOSHIBA, Tokyo (JP); TOSHIBA SOLUTIONS CORPORATION, Kawasaki-shi (JP)

(21) Appl. No.: 15/405,953

(22) Filed: Jan. 13, 2017

Related U.S. Application Data
(63) Continuation of application No. PCT/JP2014/074045, filed on Sep. 11, 2014.

(51) Int. Cl. G06F 17/30; G06F 3/06

(52) U.S. Cl. CPC G06F 17/30156; G06F 17/30097; G06F 3/0641; G06F 3/067; G06F 3/0665; G06F 3/0619

(57) ABSTRACT

According to one embodiment, a file system includes a hash value calculator, an access controller and a deduplication controller. The hash value calculator calculates a hash value of at least one data block in a file to be stored in storage. The access controller stores, when the at least one data block includes a first data block and when a first hash value of the first data block is calculated, the first data block in a first location of the storage determined based on the first hash value, by using the first hash value as an identifier. The deduplication controller prevents the first data block from being stored in the first location when an effective second data block is already stored in the first location.

### CROSS-REFERENCE TO RELATED APPLICATIONS

This application is a Continuation Application of PCT Application No. PCT/JP2014/074045, filed Sep. 11, 2014, the entire contents of which are incorporated herein by reference.

### FIELD

Embodiments described herein relate generally to a file system, a data deduplication method and a storage medium.

### BACKGROUND

Recently, the amount of data to be stored in storage devices has increased. Thus, there is demand for effective use of the limited storage capacity in storage devices. As a technique which meets this demand, a deduplication technique has attracted attention. The deduplication technique prevents duplicate data from being stored in a storage device.

In general, the deduplication technique is roughly divided into two types based on what performs deduplication. The first-type deduplication technique is applied in a file system. The second-type deduplication technique is applied in a storage device. The first-type deduplication technique is known as a method for entirely or partially storing files having the same content in the same location of a storage device. The second-type deduplication technique is known as a method for storing blocks having the same content in a storage device altogether such that the same block is referred to from different access passes.

In the first-type deduplication technique, deduplication is performed by a file system. Thus, a storage device does not require a special function for deduplication. In the second-type deduplication technique, deduplication is performed by a storage device (more specifically, the controller of a storage device). Thus, a file system does not require a special function for deduplication.

However, in the first-type deduplication technique, overhead for deduplication occurs in the file system. In the second-type deduplication technique, overhead for deduplication occurs in the storage device. Further, in the second-type deduplication technique, all the data items are transferred to the storage device by the file system for the duplication determination performed by the storage device. Thus, the amount of transferred data is not reduced.

### BRIEF DESCRIPTION OF THE DRAWINGS

FIG. 1 is a block diagram showing a typical configuration of a computer system according to one embodiment.

FIG. 2 is a view for explaining the outline of the main function of a file system shown in FIG. 1.

FIG. 3 is a view showing an example of the structure of an inode used to manage a plurality of blocks included in a file according to the embodiment.

FIG. 4 is a view showing a data structural example of the object of a block applied in the embodiment.

FIG. 5 is a view showing an example of a directory-type inode applied in the present embodiment.

FIG. 6 is a flowchart showing a typical procedure of a process for writing a file applied in the embodiment.

FIG. 7 is a flowchart showing a typical procedure of a process for reading a file applied in the embodiment.

FIG. 8 is a flowchart showing a typical procedure of a process for deleting a file applied in the embodiment.

### DETAILED DESCRIPTION

Various embodiments will be described hereinafter with reference to the accompanying drawings.

In general, according to one embodiment, a file system includes a hash value calculator, an access controller and a deduplication controller. The hash value calculator is configured to calculate a hash value of at least one data block included in a file to be stored in storage. The access controller is configured to store, when the at least one data block includes a first data block and when a first hash value of the first data block is calculated, the first data block in a first location of the storage determined based on the first hash value, by using the first hash value as an identifier. The deduplication controller is configured to prevent the first data block from being stored in the first location when an effective second data block is already stored in the first location.

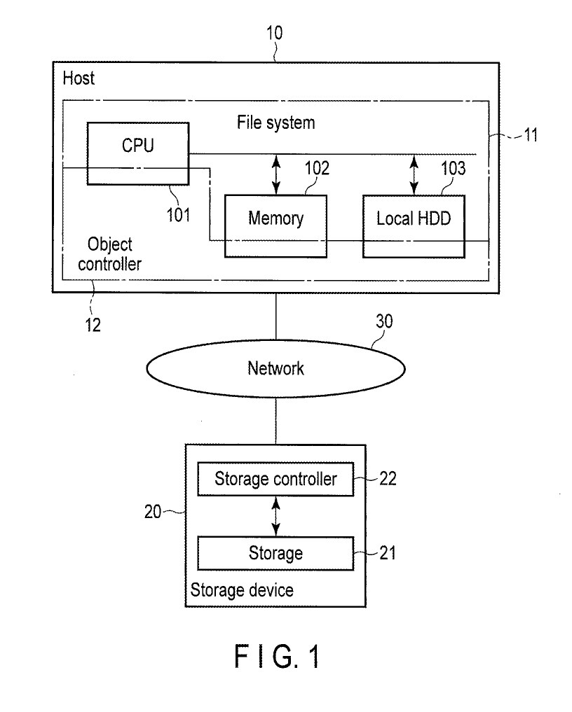

FIG. 1 is a block diagram showing a typical configuration of a computer system according to one embodiment. The computer system shown in FIG. 1 comprises a host computer (host) 10 and a storage device 20. In the present embodiment, the host 10 is connected to the storage device 20 via a network 30.

The host 10 comprises a file system 11 and an object controller 12. In the present embodiment, the file system 11 and the object controller 12 have a common hardware structure including a CPU 101, a memory 102 and a local hard disk drive (HDD) 103. However, each of the file system 11 and the object controller 12 may have a specific hardware structure including a CPU, a memory and a local HDD.

The CPU 101 functions as the main controller of the file system 11 and the object controller 12 by executing a file system program and an object control program in, for example, a time-divisional manner. The file system program and the object control program are stored in the local HDD 103 in advance. In the present embodiment, at least a part of the above programs is loaded into the memory 102 and is used by the CPU 101 in accordance with an initial program loader (IPL) which is executed by the CPU 101 when the host 10 is activated. Although omitted in FIG. 1, the IPL is stored in a nonvolatile memory such as a flash ROM in advance.

The storage device 20 comprises storage 21 and a storage controller 22. In the present embodiment, the storage 21 comprises an HDD array, for example, a redundant array of inexpensive disks or a redundant array of independent disks (RAID) including a plurality of HDDs. The storage 21 may comprise a flash array including a plurality of flash memories (in other words, a flash array in which the access speed is higher than that of an HDD array). Further, the storage 21 may be hierarchical storage which comprises low-speed storage (for example, an HDD array) and high-speed storage (for example, a flash array). The flash array may comprise a plurality of solid state drives (SDD) compatible with an HDD. The storage 21 does not have to have an array structure.

When the storage controller 22 receives an access request from the host 10 (more specifically, the object controller 12 of the host 10), the storage controller 22 accesses the storage 21. The storage controller 22 manages the area of the storage 21 based on blocks. The storage controller 22 further manages the correspondence between the logical addresses of the blocks (logical block addresses) and physical addresses allocated to the logical block addresses.

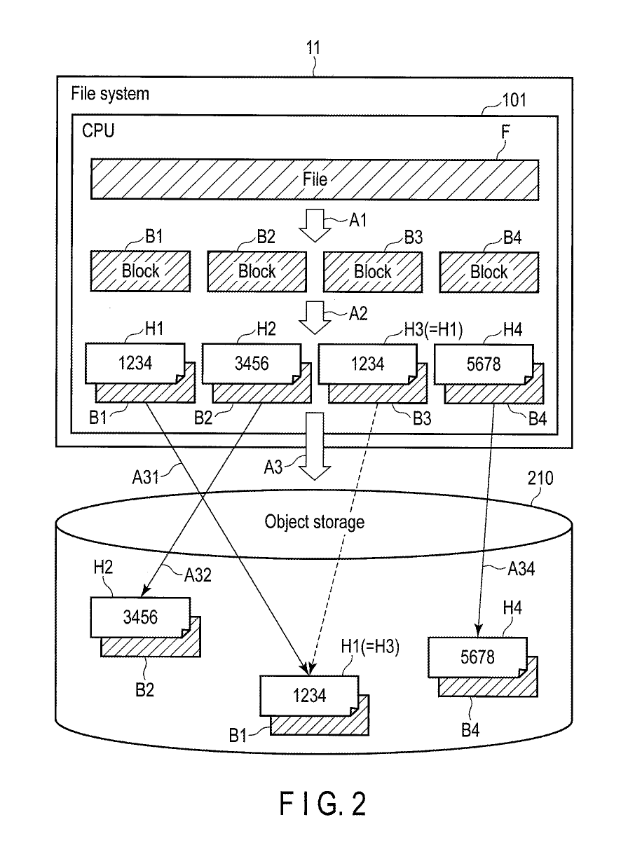

Now, this specification explains the main function of the file system 11 shown in FIG. 1, referring to FIG. 2. FIG. 2 is a view for explaining the outline of the main function of the file system 11. In the present embodiment, the storage 21 of the storage device 20 is recognized as object storage 210 by the file system 11. The object storage 210 is a type of logical storage, and is used to store data (for example, file data) based on each object. In the present embodiment, the object size (data length) is variable. However, the object size may be fixed.

FIG. 2 assumes that an application operating on the host 10 requests the file system 11 to store a file F in the object storage 210. In this case, the main controller (the CPU 101) of the file system 11 divides the file F into a plurality of data blocks, for example, four data blocks (hereinafter, simply referred to as blocks) B1, B2, B3 and B4, as shown by arrow A1 in FIG. 2. In the present embodiment, the size of blocks B1 to B4 is fixed. However, as described later, the block size may be variable.

Subsequently, the CPU 101 calculates hash values H1, H2, H3 and H4 of blocks B1, B2, B3 and B4, respectively, using a well-known hash function HF such as SHA-256, as shown by arrow A2 in FIG. 2. When the hash function HF is SHA-256, the number of bits of each of hash values H1, H2, H3 and H4 is 256. In the example of FIG. 2, hash values H1, H2, H3 and H4 are 1234, 3456, 1234 and 5678, respectively. Thus, hash value H1 is the same as hash value H3.

It is assumed that the content of block B1 corresponding to hash value H1 is different from that of block B3 corresponding to hash value H3. In this case, when the number of bits of each hash value is sufficiently great like the present embodiment, the possibility that the hash value of block B1 is the same as that of block B3, in other words, the possibility of a hash collision, can be nearly precluded. In comparison with the possibility that the storage device 20 goes wrong or data is garbled in the storage device 20, the possibility of a hash collision can be negligibly minimized. Thus, when hash value H1 is the same as hash value H3 as described above, the CPU 101 determines that blocks B1 and B3 have the same content and have duplicate data.

Based on the result of duplication determination, the CPU 101 uses hash values H1 (=H3), H2 and H4 as identifiers (IDs), and stores blocks B1, B2 and B4 corresponding to the IDs in the object storage 210 as shown by arrow A3 (more specifically, arrows A31, A32 and A34) in FIG. 2. The technology using object storage for storing a block is called an object storage technology. In the object storage technology, the above IDs and blocks are processed as object IDs and objects. Each object is called an object corresponding to a block, the object of a block, or a data object. The present embodiment is characterized in that the CPU 101 uses the hash value of a block as an object ID indicating the object of the block.

In the above block storage, the CPU 101 deals with blocks corresponding to the same ID (object ID) as the same objects for deduplication. The CPU 101 prevents blocks B1 and B3 having the same content from being redundantly stored in the object storage 210. In the example of FIG. 2, it is assumed that block storage in the object storage 210 is started from the head block B1 of the file F. In this case, the CPU 101 prevents block B3 from being stored in the object storage 210. In this manner, duplication of blocks B1 and B3 in the object storage 210 is eliminated.

Now, this specification explains the mechanism for managing the blocks of a file applicable to the present embodiment. In the present embodiment, each file is managed using an inode in accordance with the virtual file system (VFS) of Linux (registered trademark).

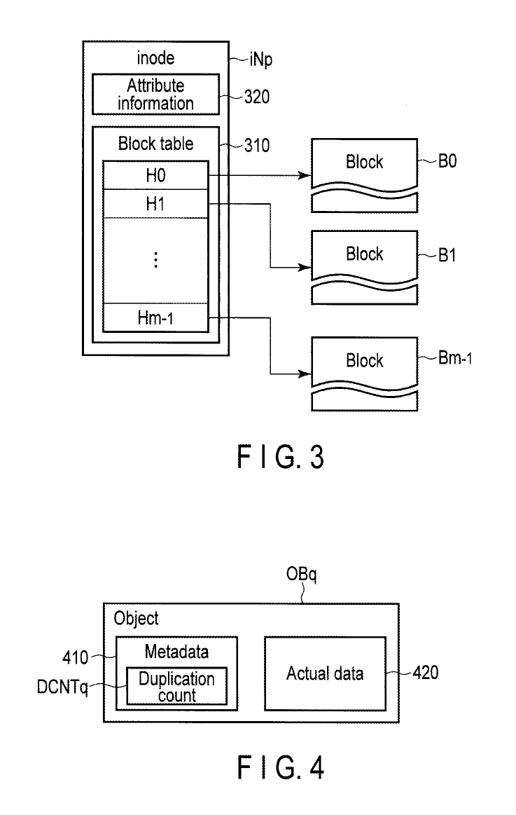

FIG. 3 shows an example of the structure of an inode iNp used to manage m blocks Bq (q=0, 1, . . . , m−1) of a file Fp. To simplify explanation, the size of each block Bq is assumed to be constant at, for example, 4 kilobytes (KB). The inode iNp is also managed as one object (the object of the inode iNp). In FIG. 3, the inode iNp includes a block table 310. The inode iNp further includes attribute information 320 indicating the attribute of the file Fp. The attribute information 320 of the file Fp is also called the metadata of the file Fp. The attribute of the file Fp includes the size of the file Fp, the access permission to the file Fp and a timestamp. The timestamp includes the date of the last access to the file Fp, the date of the last change in the file Fp, and the date of creation of the file Fp.

The block table 310 is used to record information indicating the location of each block Bq (block location information). In the conventional technique, as the block location information, the address of each block Bq is used. In the present embodiment, as the block location information, the hash value Hq of each block Bq is used.

In the present embodiment, each block Bq is logically stored in a location of the object storage 210 uniquely determined using the hash value Hq of the block Bq as an object ID. In the present embodiment, the hash value Hq of each block Bq is used as the object ID of the object OBq of the block Bq. In this manner, the object OBq of each block Bq is logically stored in a location uniquely determined based on the object ID of the object OBq (in other words, based on the hash value Hq of the block Bq).

In the present embodiment, at least a part of the physical storage area of the storage 21 (hereinafter, referred to as a physical volume) is mapped with respect to a logical volume recognized by the host 10 based on small areas having a constant size. Thus, the storage controller 22 manages the correspondence between the logical addresses (for example, logical block addresses) of small areas in the logical volume and the physical addresses of small areas in the physical volume, using an address management table.

In the present embodiment, the location of each object OBq in the object storage 210 is mapped with respect to a small area column in the logical volume. As described above, the location is indicated by the object ID of each object OBq. Thus, the object controller 12 manages the correspondence between the object ID of each object OBq and the logical block address LBAq of the head small area of a small area column in the logical volume, using an object management table. The object management table is stored in, for example, the local HDD 103 of the host 10. It is assumed that the number of bits of each logical block address LBAq is 64.

The file system 11 reads (or writes) the object OBq of a block Bq via the object controller 12 in the following manner. The file system 11 uses the hash value Hq of the block Bq as the object ID indicating the object OBq of the block Bq, and requests the object controller 12 to read (or write) the object OBq. In response to the request, the object controller 12 logically reads (or writes) the object OBq from (in) the location of the object storage 210 uniquely determined based on the hash value Hq (object ID).

It should be noted that the object OBq (more specifically, the content of the object OBq) needs to be physically read from (or written in) the storage 21 of the storage device 20. For this physical reading (or writing), the object controller 12 refers to the object management table based on the object ID of the object OBq of the block Bq (in other words, based on the hash value Hq of the block Bq). In this way, the object controller 12 obtains the logical block address LBAq associated with the object ID of the object OBq. The object controller 12 requests the storage controller 22 of the storage device 20 to read (or write) the content of the object OBq based on the obtained logical block address LBAq and the size of the object OBq.

In response to the request from the object controller 12, the storage controller 22 refers to the address management table based on the logical block address LBAq. In this way, the storage controller 22 obtains a physical address associated with the logical block address LBAq. The storage controller 22 reads (or writes) the content of the object OBq from (in) the location of the storage 21 indicated by the obtained physical address and the size of the object OBq. To simplify explanation, descriptions related to physical reading or writing of the object are omitted below.

In the present embodiment, the size of the inode iNp (more specifically, the size of the object of the inode iNp) is variable. Thus, in the present embodiment, the hash values of all the blocks Bq (B0 to Bm−1) of the file Fp can be recorded in the block table 310 of the inode iNp. In FIG. 3, for example, hash values H0, H1, . . , Hm−2, Hm−1 of blocks B0, B1, . . . , Bm−2, Bm−1 are recorded in the block table 310. In this case, blocks B0, B1, . . . Bm−2, Bm−1 are directly stored in the locations determined using hash values H0, H1, . . . , Hm−2, Hm−1 recorded in the block table 310 as IDs.

The size of the inode iNp may be fixed. Here, the number of blocks Bq of the file Fp is indicated as Np, and the number of hash values recordable in the block table 310 is indicated as Nq. When Np is less than or equal to Nq, the CPU 101 is allowed to directly manage all the blocks Bq, using the block table 310. When Np is greater than Nq, the CPU 101 may manage some blocks Bq, using the well-known indirect blocks. It is assumed that the hash values Hn and Hn+1 of blocks Bn and Bn+1 are managed using an indirect block IBx. In this case, the hash values Hn and Hn+1 of blocks Bn and Bn+1 are recorded in the indirect block IBx, and the hash value Hx of the indirect block IBx is recorded in the block table 310. In the conventional technique, the addresses of blocks Bn and Bn+1 are recorded in indirect blocks IBx, and the address of the indirect block IBx is recorded in the block table 310.

When all the blocks Bq cannot be managed in the block table 310 of the inode iNp even using indirect blocks IBx, the CPU 101 may use, for example, a double indirect block or a triple indirect block. In this case, the CPU 101 records the hash value of the next-stage indirect block instead of the address of the next-stage indirect block in a double indirect block or a triple indirect block.

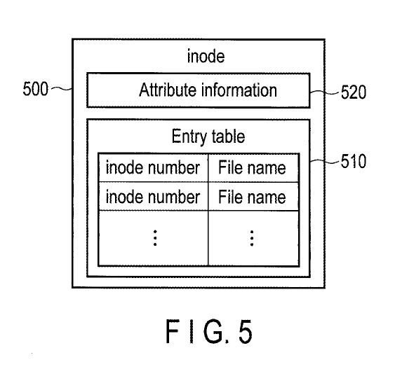

FIG. 4 shows a data structural example of the object OBq of a block Bq applied in the present embodiment. The object OBq is stored in the data area of the object storage 210. In the present embodiment, the data area is allocated to the file system 11, and is used by the file system 11. When the host 10 comprises a plurality of file systems including the file system 11, the data area may be shared by the plurality of file systems.

A plurality of data areas, for example, first and second data areas, may be prepared in the object storage 210. It is assumed that a first file system (or a group of first file systems) uses the first data area, and a second file system (or a group of second file systems) uses the second data area. Further, it is assumed that the hash value of a first object to be stored in the first data area is the same as the hash value of a second object already stored in the second data area. In this case, the first file system (or each first file system) processes the first and second objects as different objects even when the hash values are the same as each other. Thus, even when the second object is present, the first object is eliminated from the deduplication target.

For example, the inode iNp shown in FIG. 3 is also called an inode object, and is stored in the inode area of the object storage 210. In the present embodiment, the inode area is allocated to the file system 11, and is used by the file system 11. When the host 10 comprises a plurality of file systems including the file system 11, individual inode areas may be used by the plurality of file systems.

The object OBq comprises metadata 410 and actual data 420. The actual data 420 of the object OBq is the substantive data of the object OBq. When the object OBq corresponds to the block Bq of the file Fp like the present embodiment, the actual data 420 is identical with the content of the block Bq.

The metadata 410 of the object OBq indicates management information related to the object OBq, and includes a duplication count DCNTq. The duplication count DCNTq is also called a reference count, and indicates the number of blocks Bq identical with the actual data 420. The duplication count DCNTq indicates the number of blocks having the same hash value as the hash value Hq of the actual data 420 (the block Bq). The metadata 410 further includes an object ID unique to the object OBq, information indicating the size of the actual data 420, and the address (for example, the logical block address) indicating the storage destination of the actual data 420. The hash value Hq of the block Bq corresponding to the object OBq is used for the object ID of the object OBq.

In general, an inode is divided into a plurality of types. A file (more specifically, a normal file) and a directory are known as the typical types of an inode. A file-type inode is used to manage a file. The type of the inode iNp shown in FIG. 3 is a file-type. In the following explanation, a file-type inode may be referred to as a file inode. A directory-type inode may be referred to as a directory inode. An inode has an inode number unique to the inode regardless of the type of inode. The inode number of the inode (in other words, the inode object) is used as the object ID of the inode object.

FIG. 5 shows an example of a directory-type inode 500 applied in the present embodiment. The size of the inode 500 is variable in the same manner as that of the inode iNp. The inode 500 is also managed as one object (in other words, the object of the inode 500). Thus, the inode 500 may be referred to as an inode object 500. The inode 500 has, for example, an inode number iNdn, and includes a directory entry table (hereinafter, referred to as an entry table) 510 and attribute information 520. The entry table 510 is used to record the combinations of the inode numbers and names of all the files included in the directory indicated by the inode 500. When a new file is created, the combination of the inode number of an inode corresponding to the file and the name of the file is added to, for example, an empty entry of the entry table 510 of the inode 500 by the file system 11.

The file may be a directory instead of a normal file. In this case, a directory-type inode number and a directory name are recorded in the entry table 510. The size of the inode (directory inode) 500 may be fixed. In this case, the file system 11 (the CPU 101) may record the assembly of combinations of inode numbers and file names to be retained in the entry table 510 of the inode 500 so as to be dispersed into a plurality of separate objects, and record the IDs of the objects (in other words, the list of directory entries) in the inode 500.

The file system 11 uses a special block to manage the file system 11. The special block is called a super block, and is generated when the file system 11 is generated. The super block is used to record the management information of the file system 11 (hereinafter, referred to as file system management information), and is stored in, for example, the inode area of the object storage 210. The super block is also managed as an object. Thus, a special object ID is allocated to the super block.

The file system management information includes inode list information. The inode list information includes information related to the storage destination of each inode assured in advance in the inode area of the object storage 210 (hereinafter, referred to as inode management information). The inode management information includes inode numbers unique to respective inodes. The file system 11 is allowed to specify the inode having the target inode number as an ID by referring to the inode management information included in the file system management information.

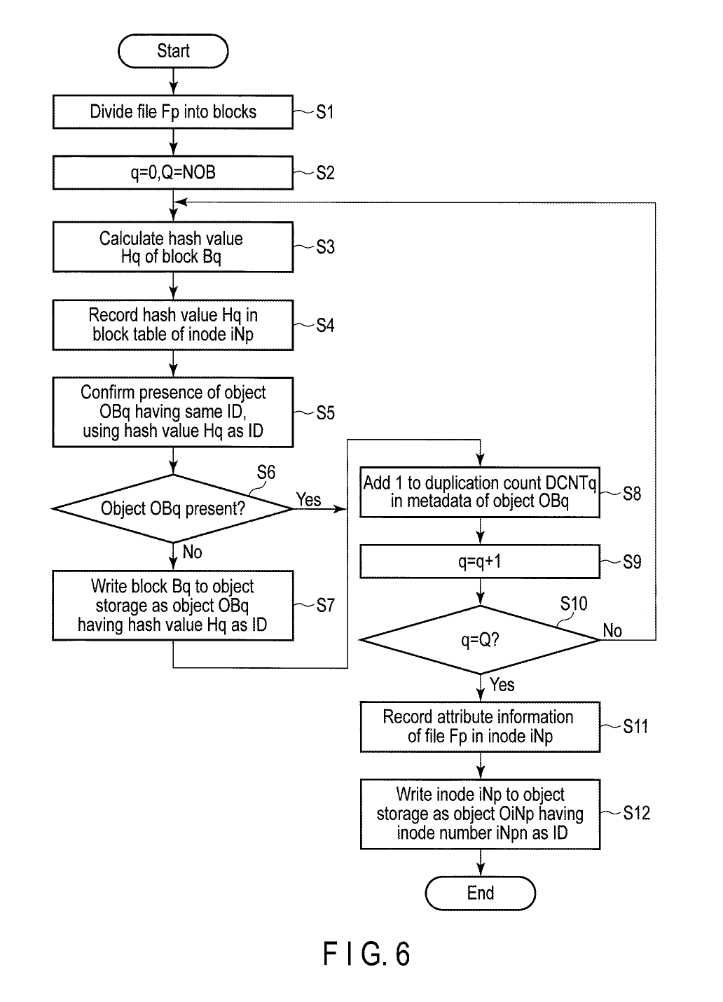

Now, this specification explains the operation of the present embodiment. First, a process which is performed for writing a file by the CPU 101 of the file system 11 is explained using an example in which a file Fp is written with reference to FIG. 6. FIG. 6 is a flowchart showing a typical procedure of a process for writing a file applied in the present embodiment. To simplify explanation, the size of the file Fp is assumed to be an integral multiple of 4 KB.

It is assumed that an application program executed in the host 10 requests the file system 11 to write a file Fp. The CPU 101 of the file system 11 begins a process for writing the file. The CPU 101 functions as a file access controller, and divides the file Fp into, for example, a plurality of blocks Bq (q=0, 1, . . . ) having the size of 4 KB (step S1). The blocks Bq are stored in, for example, the memory 102. Here, the number of blocks Bq is assumed to be m.

Subsequently, the CPU 101 initializes variables q and Q so as to be 0 and m, respectively (step S2). Variable q indicates the relative position of the block Bq in the file Fp. Variable Q indicates the number of split blocks Bq. Subsequently, the CPU 101 selects the block Bq (a first block) indicated by variable q (=0) from the local HDD 102, and stores the selected block Bq in the work area of the memory 102. The CPU 101 functions as a hash value calculation module, and calculates the hash value Hq of the content of the block Bq stored in the work area of the memory 102 (step S3). The CPU 101 proceeds to step S4.

In step S4, the CPU 101 functions as a file management module, and records the calculated hash value Hq in the block table 310 of the inode iNp having the inode number iNpn associated with the name of the file Fp in the following manner. First, the CPU 101 refers to an entry table 510a of an inode 500a based on the name of the file Fp. Thus, the CPU 101 obtains the inode number iNpn associated with the name of the file Fp. The CPU 101 searches the entry table 510a of the inode 500a for the inode number iNpn associated with the name of the file Fp.

Subsequently, the CPU 101 uses the detected inode number iNpn as an ID, and reads the inode iNp having the detected inode number iNpn from the inode area of the object storage 210 via the object controller 12. The CPU 101 stores the read inode iNp in the work area of the memory 102. The CPU 101 records the hash value Hq of the block Bq in the block table 310 of the inode iNp stored in the work area of the memory 102.

Subsequently, the CPU 101 functions as a deduplication controller. The CPU 101 uses the hash value Hq of a block Bq as an object ID, and confirms the presence of an object OBq having the same object ID as the above object ID in the following manner (step S5). The CPU 101 uses the hash value Hq of a block Bq as an object ID, and reads an object from the location of the object storage 210 uniquely determined based on the hash value Hq via the object controller 12. The CPU 101 confirms that the target object OBq is present on condition that an effective object is stored in the above location.

Subsequently, the CPU 101 determines the result of confirmation of the target object OBq. The CPU 101 determines whether the target object OBq is present in the above location (step S6). Here, it is assumed that the target object OBq is not present in the above location (NO in step S6). In other words, it is assumed that an effective block having the same content as the block Bq is not present in the location (a first location) uniquely determined based on the hash value Hq of the block Bq. In this case, the CPU 101 determines that none of blocks stored in the data area of the object storage 210 used by the file system 11 overlaps the block Bq, and thus, there is no need to perform deduplication related to the block Bq.

Subsequently, the CPU 101 functions as the file access controller again. The CPU 101 writes the block Bq (the first block) in the above location as an object OBq having the hash value Hq as an object ID (step S7). This writing is performed by the object controller 12 when the CPU 101 requests the object controller 12 to write the object OBq.

The object OBq includes the metadata 410 and the actual data 420 as shown in FIG. 4. The metadata 410 includes an object ID identical with the hash value Hq. The metadata 410 of the object OBq further includes the duplication count DCNTq in which the value is 0 (a default value). The actual data 420 is identical with the content of the block Bq. After step S7, the CPU 101 functions as the deduplication controller and proceeds to step S8.

In a manner different from that of the above example, it is assumed that the target object OBq (more specifically, an object having a block having the same content as the block Bq) is present in the above location (YES in step S6). In other words, it is assumed that an effective block (a second block) having the same content as the block Bq is already present in the location uniquely determined based on the hash value Hq of the block Bq. In this case, the CPU 101 determines that the block Bq overlaps the effective block present in the above location, and thus, there is a need to perform deduplication related to the block Bq. The CPU 101 functions as the deduplication controller, skips step S7 for deduplication, and then, proceeds to step S8. In other words, the CPU 101 prevents the block Bq from being written to the above location as the object OBq for deduplication, and then, proceeds to step S8.

In step S8, the CPU 101 adds 1 to the duplication count DCNTq of the metadata 410 of the object OBq. When the target object OBq is not present as a result of determination (NO in step S6), the duplication count DCNTq is updated from the default value 0 to 1. When the duplication count DCNTq is equal to 1, the number of blocks Bq identical with the actual data 420 of the object OBq is 1. When the target object OBq is present as a result of determination (YES in step S6), the duplication count DNCTq is updated so as to be 2 or greater since the duplication count DNCTq is an integer greater than or equal to 1.

Subsequently, the CPU 101 functions as the file access controller, and adds 1 to variable q (step S9). The CPU 101 determines whether variable q after the addition of 1 is equal to variable Q (=m) (step S10). When variable q after the addition of 1 is not equal to variable Q (NO in step S10), the CPU 101 determines that a block Bq to be processed remains. In this case, the CPU 101 returns to step S3. The CPU 101 performs steps S3 to S10 or steps S3 to S6 and S8 to S10 in the same manner as the above description. In step S10, the CPU 101 may determine whether variable q after the addition of 1 is greater than or equal to variable Q, or whether variable q after the addition of 1 exceeds Q−1.

When the CPU 101 repeats the above operation Q (=m) times, variable q after the addition of 1 is equal to variable Q (YES in step S10). In this case, the CPU 101 determines that no block Bq to be processed remains. Thus, the CPU 101 proceeds to step S11.

In step S11, the CPU 101 functions as the file management module, and records new attribute information 320 of the file Fp in the inode iNp stored in the work area of the memory 102. The CPU 101 updates the old attribute information 320 of the inode iNp with the new attribute information 320.

Subsequently, the CPU 101 writes a new inode iNp including a new block table 310 and the new attribution information 320 to the inode area of the object storage 210 as an object OiNp having an inode number iNpn as an ID (step S12). The CPU 101 updates the old inode iNp (old object OiNp) with the new inode iNp (new object OiNp). Thus, the process for writing the file is terminated. The writing of the object OiNp in step S12 is performed by the object controller 12 when the CPU 101 request the object controller 12 to write the object OiNp.

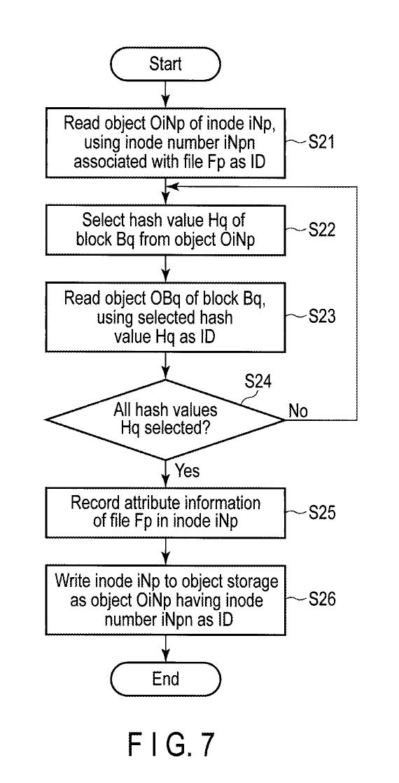

Subsequently, a process which is performed for reading a file by the CPU 101 of the file system 11 is explained with an example in which a file Fp is read with reference to FIG. 7. FIG. 7 is a flowchart showing a typical procedure of a process for reading a file applied in the present embodiment.

It is assumed that an application program requests the file system 11 to read a file Fp. The CPU 101 of the file system 11 begins a process for reading the file. First, the CPU 101 functions as the file access controller, uses the inode number iNpn associated with the file Fp, and reads the object OiNp of an inode iNp from the object storage 210 (step S21). This reading is performed by the object controller 12 when the CPU 101 requests the object controller 12 to read the object OiNp.

The read object OiNp of the inode iNp is stored in the work area of the memory 102. In the same manner as that of the above process for reading a file, the inode number iNpn is obtained when the CPU 101 refers to the entry table 510a of the inode 500a based on the name of the file Fp.

Subsequently, the CPU 101 selects the hash value Hq of a block Bq which has not been selected yet from the block table 310 of the inode iNp included in the read object OiNp (step S22). Here, the hash value Hq of the block Bq is selected from the q (=0)th entry of the block table 310.

Subsequently, the CPU 101 uses the selected hash value Hq as an object ID, and reads the object OBq of the block Bq from the object storage 210 (step S23). The CPU 101 reads the object OBq having the selected hash value Hq as an object ID. The read object OBq is stored in the work area of the memory 102.

Subsequently, the CPU 101 determines whether all the hash values Hq recorded in the block table 310 of the inode iNp included in the object OiNp read in step S21 are selected (step S24). When a hash value Hq which has not been selected yet is present in the block table 310 of the inode iNp (NO in step S24), the CPU 101 returns to step S22. The CPU 101 performs steps S22 to S24 in the same manner as that of the above case.

It is assumed that steps S22 to S24 are repeatedly applied to all the hash values Hq recorded in the block table 310 of the inode iNp (YES in step S24). In this case, the CPU 101 proceeds to step S25.

In step S25, the CPU 101 functions as the file management module, and records new attribute information 320 of the file Fp in the inode iNp included in the object OiNp stored in the work area of the memory 102. The CPU 101 updates the old attribute information 320 of the inode iNp with the new attribute information 320.

Subsequently, the CPU 101 writes a new inode iNp including a new block table 310 and the new attribute information 320 to the inode area of the object storage 210 via the object controller 12 as an object OiNp having an inode number iNpn as an ID (step S26). In this way, the old iNp (old object OiNp) is updated with the new inode iNp (new object OiNp). Thus, the process for reading the file is terminated.

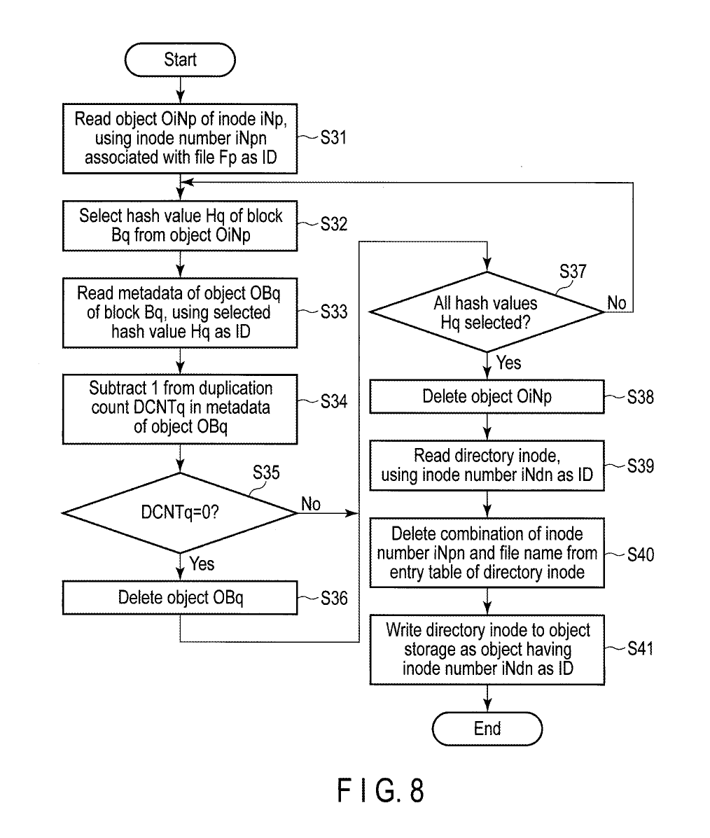

Now, this specification explains a process which is performed for deleting a file by the CPU 101 of the file system 11 with an example in which a file Fp is deleted with reference to FIG. 8. FIG. 8 is a flowchart showing a typical procedure of a process for deleting a file applied in the present embodiment.

It is assumed that an application program requests the file system 11 to delete a file Fp. The CPU 101 of the file system 11 begins a process for deleting the file. First, the CPU 101 functions as the file access controller, uses the inode number iNpn associated with the file Fp as an ID, and reads the object OiNp of an inode iNp from the object storage 210 (step S31). The read object OiNp of the inode iNp is stored in the work area of the memory 102.

Subsequently, the CPU 101 selects the hash value Hq of a block Bq which has not been selected yet from the block table 310 of the inode iNp included in the read object OiNp (step S32). Here, the hash value Hq of the block Bq is selected from the q (=0)th entry of the block table 310.

Subsequently, the CPU 101 uses the selected hash value Hq as an object ID and reads the metadata 410 of the object OBq of the block Bq from the object storage 210 (step S33). The read metadata 410 of the object OBq is stored in the work area of the memory 102.

Subsequently, the CPU 101 functions as a file deletion controller, and subtracts 1 from the duplication count DCNTq of the metadata 410 included in the object OBq read in step S33 (step S34). The CPU 101 determines whether the duplication count DCNTq after the subtraction of 1 is equal to 0 (step S35).

When the duplication count DCNTq after the subtraction of 1 is equal to 0 (YES in step S35), the CPU 101 determines that the number of blocks Bq identical with the actual data 420 included in the object OBq is made 0 by the deletion of the file Fp this time. In this case, the CPU 101 deletes the object OBq from the object storage 210 (step S36). The CPU 101 proceeds to step S37.

When the duplication count DCNTq after the subtraction of 1 is not equal to 0 (NO in step S35), the CPU 101 determines that the number of blocks Bq identical with the actual data 420 included in the object OBq is not made 0 by the deletion of the file Fp this time. In this case, the CPU 101 skips step S36, and proceeds to step S37.

In step S37, the CPU 101 determines whether all the hash values Hq recorded in the block table 310 of the inode iNp included in the read object OiNp are selected in the same manner as step S24 in the above process for reading a file. When a hash value Hq which has not been selected yet is present in the block table 310 of the inode iNp (NO in step S37), the CPU 101 returns to step S32. The CPU 101 performs steps S32 to S37 or steps S32 to S35 and S37 in the same manner as the above case.

It is assumed that steps S32 to S37 or steps S32 to S35 and S37 are repeatedly applied to all the hash values Hq recorded in the block table 310 of the inode iNp (YES in step S37). In this case, the CPU 101 deletes the object OiNp from the object storage 210 (step S38). The deletion of the object OiNp in step S38 is performed by the object controller 12 when the CPU 101 requests the object controller 12 to delete the object OiNp.

Subsequently, the CPU 101 uses the inode number iNdn of the inode (directory inode) 500a, and reads the inode (inode object) 500a (step S39). The read inode 500a is stored in the work area of the memory 102.

Subsequently, the CPU 101 deletes the combination of the inode number iNpn and the name of the file Fp from the entry table 510a of the inode 500a read in step S39 (step S40). The CPU 101 writes, to the inode area of the object storage 210, the inode 500a including the entry table 510a from which the combination of the inode number iNpn and the name of the file Fp is deleted as an object having the inode number iNdn of the inode 500a as an ID (step S41). In this way, the process for deleting the file is terminated.

Now, this specification briefly explains the well-known process for creating a file applied in the present embodiment. It is assumed that an application operating on the host 10 requests the file system 11 to create a new file Fp. In this case, the CPU 101 of the file system 11 functions as the file management module, and obtains an unused inode number. Here, it is assumed that an inode number iNpn is obtained.

Subsequently, the CPU 101 creates a file inode iNp in the work area of the memory 102, and records the attribute information of the file Fp in the file inode iNp. The CPU 101 uses the inode number iNpn as an ID, and writes, to the inode area of the object storage 210, the file inode iNp in which the attribute information of the file Fp is recorded.

Subsequently, the CPU 101 uses the inode number iNdn of the inode (directory inode) 500a as an ID, and reads the inode (inode object) 500a. The CPU 101 adds the combination of the inode number iNpn and the name of the file Fp to the entry table 510 of the read inode 500a. The CPU 101 writes, to the inode area of the object storage 210, the inode 500a including the entry table 510a to which the combination of the inode number iNpn and the name of the file Fp is added, as an object having the inode number iNdn as an ID. In this way, the process for creating the file is terminated.

As described above, in the present embodiment, the file system 11 determines (or specifies) the location of the block to be written to the object storage 210, using the hash value of the block calculated based on the content (that is, the data) of the block as an ID (object ID). For example, when a block Bq needs to be written to the object storage 210, the file system 11 accesses the above location, using the hash value Hq of the block Hq as an ID. By only this access, the file system 11 is allowed to easily determine whether a block having the same ID as the hash value Hq is already stored in the storage device 20. When an effective block is stored in the above location, the file system 11 does not necessarily have to calculate the hash value of the effective block or compare the calculated hash value with the hash value Hq of the block Bq for the above determination.

As described above, in the present embodiment, on the file system 11 side, the information indicating the location of a block Bq is merely changed from an address in the conventional technique to the hash value Hq of the block Eq. Thus, overhead for deduplication can be reduced. On the storage device 20 side, the storage controller 22 may store a block Bq in the location uniquely determined by the hash value Hq of the block Bq in accordance with a request from the file system 11 side. Thus, the determination for duplication is unnecessary.

In the present embodiment, the size of Q (=m) blocks (data blocks) Bq obtained by dividing a file Fp is fixed. The size of each of the Q blocks Bq is indicated by the size information included in the metadata 410 of the object OBq of the block Bq. Thus, the size of each of the Q blocks Bq may be variable. The file Fp may be divided into a plurality of blocks so as to include a block having the same content as the content of a block already stored in the object storage 210.

It is assumed that each of a plurality of files includes a plurality of successive blocks having the same content, for example, two blocks Ba and Bb. In this case, objects OBa and OBb of blocks Ba and Bb may be put together into one object OBab. In other words, blocks Ba and Bb may be put together into one block Bab.

When the CPU 101 functions as the file management module, and the size of each block is variable, the rate of deduplication can be improved. When a plurality of successive blocks are put together, the access performance can be improved.

It is assumed that, after the CPU 101 functions as the file access controller, for example, the object OBq of the block Bq is read using the hash value Hq selected in step S22 or S32 as an ID (step S23 or S33). In this case, the CPU 101 may calculate the hash value of the actual data 420 of the read object OBq, in other words, the hash value of the block Bq, and compare the calculated hash value with the selected hash value Hq. The CPU 101 detects an error in the process for reading the object OBq of the block Bq based on the result of comparison. When the calculated hash value is not equal to the selected hash value Hq, the CPU 101 determines that an error has occurred in the process for reading the object OBq of the block Bq. With this structure, an error can be checked without increasing the amount of calculation.

It is assumed that, in a manner different from that of the above embodiment, the storage 21 of the storage device 20 is hierarchical storage comprising two types of storage in which the access performance differs, for example, high-speed storage and low-speed storage. In this case, the metadata 410 of each object OBq may include the number of accesses to the object OBq (the access count). In this structure, the CPU 101 may function as a hierarchical management module, store, in the high-speed storage, an object in which the access count exceeds, for example, a threshold, and store, in the low-speed storage, an object in which the access count is less than or equal to the threshold. In this way, the objects may be stratified depending on the access count (that is, the access frequency).

In general, an object OBq is copied such that the copies are recorded in a plurality of storage media, for example, a plurality of HDDs of the storage 21 to improve the reliability and performance. In such a system requiring an object OBq to be copied, the number of copies of the object OBq may be determined based on the duplication count DCNTq included in the metadata 410 of the object OBq. The CPU 101 may function as a replication controller such that, as the greater the duplication count DCNTq is, the more copies are created for the object OBq. Thus, the access performance can be improved by increasing the number of copies of an object having a large number of duplications.

### Modification Example

Now, this specification explains a modification example of the above embodiment. In the above embodiment, the storage 21 of the storage device 20 is recognized as the object storage 210 by the file system 11. Thus, the above embodiment assumes that the file system 11 uses object storage. Therefore, the host 10 requires the object controller 12. However, in the present modification example, the storage 21 of the storage device 20 is recognized as block storage by the file system 11. The modification example assumes that the file system 11 does not use object storage although the file system 11 uses block storage.

In such a structure, it is assumed that the CPU 101 of the file system 11 needs to store a block Bq in block storage. In this case, the CPU 101 may function as the file access controller, and store, in the block storage, the combination of metadata corresponding to the metadata 410 of the object OBq of the block Bq (hereinafter, referred to as block management metadata) and the content of the block Bq (hereinafter, referred to as the metadata block combination). The block management metadata includes the duplication count DCNTq in the same manner as the metadata 410 of the object OBq. The block management metadata further includes information indicating the hash value Hq of the block Bq (in other words, the object ID of the object OBq), and the size SZq of the whole metadata block combination.

To write the metadata block combination including the content of the block Bq to the block storage, the CPU 101 determines an address indicating the write destination of the metadata block combination, for example, a logical block address LBAq, in the following manner. In the present embodiment, the number of bits of the hash value Hq is 256. The number of bits of the logical block address LBAq is 64. Thus, the hash value Hq is longer than the logical block address LBAq. The CPU 101 determines the predetermined portion of 64 bits of the hash value Hq, for example, the initial 64 bits, as the logical block address LBAq.

The CPU 101 requests the storage controller 22 of the storage device 20 to write the metadata block combination based on the determined logical block address LBAq and the size SZq of the metadata block combination. In this way, the CPU 101 is allowed to write the metadata block combination to the area which begins with the logical block address LBAq and has the size SZq (in the block storage). The operation of the storage controller 22 is the same as that of the above embodiment.

In the present modification example, a part of the hash value Hq is used as the logical block address LBAq. Thus, the logical block address LBAq may be identical with the logical block address LBAr determined based on a hash value Hr different from the above hash value Hq.

When a metadata block combination having a hash value Hr is already stored in the area which begins with the above logical block address LBAq (=LBAr) (hereinafter, referred to as an LBAq area), the CPU 101 performs an operation for recalculating the hash value of the block Bq (in other words, a rehash operation). Specifically, the CPU 101 calculates a hash value Hq′ of the hash value Hq based on the hash value Hq, and uses the hash value Hq′ as the hash value of the block Bq. The CPU 101 may add a constant value (for example, 1) to the hash value Hq, and use the result of addition as the hash value of the block Bq. When the metadata block combination already stored in the LBAq area has the hash value Hq, the CPU 101 determines that deduplication is needed. In this case, the CPU 101 adds 1 to the duplication count DCNTq included in the block management metadata of the metadata block combination already stored in the LBAq area.

In the present modification example, even when the storage used by the file system 11 is common block storage instead of object storage, the function can be equivalent to that when object storage is used, regarding deduplication.

In the above embodiment, the host 10 uses the storage device 20 via the network 30. However, a plurality of hosts including the host 10 may be connected to the network 30 such that the hosts use the storage device 20 via the network 30. Alternatively, a plurality of storage devices including the storage device 20 may be connected to the network 30 such that the host 10 or a plurality of hosts use the storage devices. The host 10 (or a plurality of hosts) may use the storage device 20 (or a plurality of storage devices) via a connection means other than the network 30, such as a fiber channel (FC), a serial attached SCSI (SAS) or a serial AT attachment (SATA).

In the above embodiment, the storage 21 and the storage controller 22 are provided independently from the host 10. However, the storage 21 and the storage controller 22 may be incorporated into the host 10.

Each of the file access controller, the hash value calculation module, the file management module, the deduplication controller, the file deletion controller, the hierarchical management module and the replication controller (function elements) is a software module realized when the CPU 101 of the file system 11 executes a storage control program. However, at least one of these function elements may be realized by a hardware module.

According to at least one of the embodiments explained above, it is possible to reduce overhead and the amount of transferred data in connection with deduplication.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A file system comprising:
a hash value calculator configured to calculate a hash value of at least one data block included in a file to be stored in storage;
an access controller configured to store, when the at least one data block includes a first data block and when a first hash value of the first data block is calculated, the first data block in a first location of the storage determined based on the first hash value, by using the first hash value as an identifier; and
a deduplication controller configured to prevent the first data block from being stored in the first location when an effective second data block is already stored in the first location.

2. The file system of claim 1, wherein:
the access controller is configured to divide the file into a plurality of data blocks including the first data block;
the hash value calculator is configured to calculate a hash value of each of the data blocks;
the deduplication controller is configured to determine whether deduplication of each of the data blocks is needed based on whether an effective data block is stored in a location of the storage determined based on the calculated hash value of each of the data blocks; and
the access controller is configured to store the first data block in the first location when the deduplication of the first data block is not needed as a result of determination.

3. The file system of claim 2, further comprising a file manager configured to manage the location of the storage in which each of the data blocks of the file is stored, by using an inode associated with the file,
wherein the access controller is configured to read the data blocks from the storage by specifying the location of the storage in which each of the data blocks of the file is stored based on the inode associated with the file, when the file needs to be read.

4. The file system of claim 3, wherein the inode associated with the file includes a block table in which the calculated hash value of each of the data blocks is recorded.

5. The file system of claim 3, wherein:
the hash value calculator is configured to calculate the hash value of the read first data block, when the first data block is read from the first location;
the access controller is configured to
store a combination of metadata of the first data block including the first hash value and the first data block in the first location, when the deduplication of the first data block is not needed as a result of determination, and
detect an error in reading the first data block by comparing the calculated hash value with the first hash value included in the metadata of the first data block, when the first data block is read from the first location and when the hash value of the read first data block is calculated.

6. The file system of claim 2, wherein:
the access controller is configured to store, in the first location, a combination of metadata of the second data block and the second data block, when the second data block needs to be stored in the first location, the metadata including a duplication count used to indicate the number of data blocks having the same hash value as the hash value of the second data block; and
the deduplication controller is configured to add 1 to the duplication count included in the metadata of the second data block stored in the first location, when the deduplication of the first data block is needed as a result of determination.

7. The file system of claim 6, further comprising a replication controller configured to create a copy of each data block stored in the storage,
wherein the replication controller is configured to determine the number of copies of the second data block based on the duplication count included in the metadata of the second data block.

8. The file system of claim 2, wherein the access controller is configured to store, in the first location, a combination of metadata of the first data block and the first data block, the metadata including a duplication count used to indicate the number of data blocks having the same hash value as the hash value of the first data block, when the deduplication of the first data block is not needed as a result of determination.

9. The file system of claim 1, wherein:
the storage comprises object storage;
the first location of the object storage is determined based on an object identifier of a first object including a combination of metadata of the first data block and the first data block; and
the access controller is configured to store the first object in the first location of the object storage determined based on the object identifier of the first object, by using the first hash value of the first data block as the object identifier of the first object.

10. The file system of claim 1, wherein:
the storage comprises block storage;
a first address specifying the first location of the block storage is indicated by using a predetermined portion of the first hash value of the first data block; and
the access controller is configured to store a combination of metadata of the first data block and the first data block in the first location of the block storage specified by the first address.

11. A data deduplication method applied to a file system, the method comprising:
calculating a hash value of at least one data block included in a file to be stored in storage;
storing, when the at least one data block includes a first data block and when a first hash value of the first data block is calculated, the first data block in a first location of the storage determined based on the first hash value, by using the first hash value as an identifier; and
preventing the first data block from being stored in the first location when an effective second data block is already stored in the first location.

12. A non-transitory computer-readable storage medium having stored thereon a computer program which is executable by a computer, the computer program controlling the computer to execute functions of:
calculating a hash value of at least one data block included in a file to be stored in storage;
storing, when the at least one data block includes a first data block and when a first hash value of the first data block is calculated, the first data block in a first location of the storage determined based on the hash value, by using the first hash value as an identifier; and
preventing the first data block from being stored in the first location when an effective second data block is already stored in the first location.
